(19) United States
(12) Patent Application Publication
(10) Pub. No.: US 2025/0264328 A1
(43) Pub. Date: Aug. 21, 2025

(54) PRECISE CORE PITCH MEASUREMENT

(71) Applicant: CORNING RESEARCH & DEVELOPMENT CORPORATION, CORNING, NY (US)

(72) Inventors: Chia-Hang Chang, Taoyuan City (TW); Ximao Feng, San Mateo, CA (US); Chunlei He, Dongguan City (CN); Wen-Lung Kuang, Taoyuan City (TW); Shudong Xiao, Fremont, CA (US); Andy Fenglei Zhou, Fremont, CA (US)

(21) Appl. No.: 19/203,955

(22) Filed: May 9, 2025

Related U.S. Application Data
(63) Continuation of application No. PCT/US2023/036852, filed on Nov. 6, 2023.
(60) Provisional application No. 63/425,332, filed on Nov. 15, 2022.

(51) Int. Cl. G01B 11/27

(52) U.S. Cl. CPC G01B 11/272

(57) ABSTRACT

A method for determining a core pitch value and/or error of an optical fiber positioned in a two-dimensional fiber array unit is provided herein. The fiber array unit includes a first layer and a second layer of optical fibers. The method comprises positioning one of the fiber array unit or a core pitch measurement device relative to each other to enable measurement of at least one core pitch value. The method continues by measuring a first horizontal and vertical component corresponding to a first optical fiber in the first layer, and a second horizontal component and a vertical component corresponding to the optical fiber in the second layer. The method continues by determining an adjusted second vertical component based on an angle of the end face of the fiber array unit, the first vertical component and the second vertical component, and determining a core pitch value and/or error therefrom.

### PRIORITY APPLICATION

This application is a continuation of International Patent Application Serial No. PCT/US2023/036852 filed on Nov. 6, 2023, which claims priority to U.S. Application No. 63/425,332, filed Nov. 15, 2022, the entirety of which is incorporated herein by reference.

### FIELD

Embodiments of the present disclosure relate generally to fiber array units, and more particularly to precise measurements of the core pitch of the optical fibers within the fiber array unit.

### BACKGROUND

Fiber array units comprise one or more optical fibers which are configured to transmit data. The fiber array unit may be coupled to other assemblies, for example, transmitters, receivers and/or other optical fibers. In this regard, at each coupling point there may be a yield loss due to the coupling of the optical fibers and the other assemblies. The higher the yield loss, the less effective the fiber array unit is, as data and the ability to transmit data can decrease at each coupling.

The coupling losses may be amplified by inaccurate spacing of the beams transmitted from the optical fibers within the fiber array unit. In this regard, inaccurate spacing may derive from positioning errors, polish angles errors, imperfections on the end face of the optical fibers, shifting (e.g., due to adhesive), and other errors.

To account for coupling losses, each fiber array unit may be manufactured with a tolerance. The tolerance may allow the beam from each fiber to emit within a certain parameter threshold corresponding to an expected position of the optical fiber in the fiber array unit. In this regard, at the ends of the tolerance (e.g., the ends of the parameter threshold) the yield from the optical fiber may still be within an acceptable range. However, as fiber array units are made on the microcin scale, a small error in measurement (e.g., 0.2 microns) may generate large yield losses.

### SUMMARY

A fiber array unit may comprise a single layer of optical fibers positioned on a first substrate, or multiple layers of optical fibers layered on top of one another, such as with a spacer in between. Each optical fiber is positioned and secured (e.g., adhesive, welding, sintering with nano-particles) to the respective substrate, thus, once the optical fibers are positioned they are unable to be repositioned, such as to adjust for any errors.

After assembly, a core pitch value of each fiber within the fiber array may be taken. The core pitch value may comprise a horizontal component and a vertical component to indicate the position of the core of the optical fiber, such as in relation to the other optical fibers within the fiber array unit. The measured core pitch value may be compared to a desired core pitch value to determine the core pitch error of each of the optical fibers within the fiber array unit.

In order to maintain the integrity of data transfer and to minimize yield losses, the core pitch error of each optical fiber is determined. In this regard, a lower core pitch error creates lower yield losses through the data transfer. Each data transfer assembly may define a tolerance, indicating the maximum allowable core pitch error acceptable for the data transfer. To accurately determine if the optical fibers within the fiber array unit are within the tolerance, the core pitch value of each optical fiber should be precisely determined. Since fiber array units are manufactured on a micron scale, a small inaccuracy in core pitch value (e.g., due to either the vertical component and/or the horizontal component) may result in a fiber array unit being out of the tolerance range-which may require, for example, discarding of the entire fiber array unit.

Notably, however, current measurement devices are limited in their ability to accurately determine vertical components of core pitch values of optical fibers in two-dimensional fiber array units. In particular, when the ends of the two layers of optical fibers extend along an end face of the fiber array unit that is angled (e.g., not perpendicular to a bottom surface of a base of the fiber array unit) the relative distances and angles to the measurement device(s) make current vertical component measurements inaccurate. This results in a misunderstanding of whether the optical fibers are actually within the acceptable tolerance (or not).

Example embodiments of the present disclosure are directed to methods for accurately determining the positioning of cores of optical fibers in a fiber array unit, particularly for fiber array units that have an angled end face. In this regard, embodiments of the present disclosure account for the angled end face and adjust the core pitch measurement values to accurately reflect the core pitch value. Thereafter, the adjusted core pitch value can be accurately used to determine the viability of the fiber array unit. Corresponding methods of manufacturing such fiber array units and confirming core pitch error tolerances are also provided herein.

In an example embodiment, a method for determining a core pitch value of an optical fiber positioned in a two-dimensional fiber array unit is provided. The two-dimensional fiber array unit comprises a first fiber array layer, and a second fiber array layer. The first fiber array layer comprises a first optical fiber defining a first end face configured to emit a first beam. The second fiber array layer comprises the optical fiber defining a second end face configured to emit a second beam. The first fiber array layer and the second fiber array layer are spaced vertically apart. The first end face and the second end face are arranged on an angled end face of the fiber array unit. The angled end face extends from a base of the fiber array unit at an angle that is not perpendicular to a bottom surface of the base of the fiber array unit. The method comprises positioning of the fiber array unit or at least one core pitch measurement device relative to each other to enable measurement of at least one core pitch value. The method further comprises measuring using the at least one core pitch measurement device, a first horizontal component and a first vertical component corresponding to the first optical fiber of the first fiber array layer. The method further comprises measuring, using the at least one core pitch measurement device, a second horizontal component and a second vertical component corresponding to the optical fiber of the second fiber array layer. The method further comprises determining an adjusted second vertical component of the optical fiber based on the angle of the angled end face, the measured first vertical component and the measured second vertical component. The method further comprises determining the core pitch value of the optical fiber based on the measured second horizontal component and the adjusted second vertical component.

In some embodiments, the first optical fiber and the optical fiber are parallel. In some embodiments, the measurement direction of the at least one core pitch measurement device may be positioned so as to be parallel to the bottom surface of the base of the fiber array unit. In some embodiments, the angled face of the two-dimensional fiber array unit may have a glass cover.

In some embodiments, the adjusted second vertical component of the second beam may be provided by the following equation:

$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$

wherein Y′ is the adjusted second vertical component of the second beam, α is the angle of the angled end face, h′ is a measured vertical component distance between the measured first vertical component and the measured second vertical component, n₀ is a refractive index of air, and n₁ is a refractive index of the angled end face of the fiber array unit.

In some embodiments, the two-dimensional fiber array unit may be positioned on a wedge that is positioned on a flat surface, wherein the wedge is configured such that the angled end face is normal to the flat surface. In some embodiments, the adjusted second vertical component is provided by the following equation: Y′=h sin (α), wherein Y′ is the adjusted second vertical component of the second exit pitch, α is the angle of the angled end face, and h is a distance between the measured first vertical component and the measured second vertical component.

In some embodiments, the method may further comprise determining a first core pitch value of the first optical fiber based on the measured first horizontal component and the measured first vertical component.

In some embodiments, the method may further comprise determining a core pitch error based on the adjusted second vertical component, the measured second horizontal component, a desired second horizontal component and a desired second vertical component, wherein the desired second horizontal component and the desired second vertical component yield desirable transmission characteristics. In some embodiments, the core pitch error is determined by the following equation: dRᵢ=\sqrt{dXᵢ²+dYᵢ²}, wherein dRᵢ is the core pitch error, dXᵢ is the difference between the desired second horizontal component and the measured second horizontal component, and dYᵢ is the difference between the desired second vertical component and the adjusted second vertical component.

In some embodiments, the first end face and the second end face may be coated with an anti-reflective coating. In some embodiments, the method may further comprise repositioning one of the two-dimensional fiber array unit or the at least one core pitch measurement device to enable core pitch measurement of a second core pitch value.

In yet another example embodiment, a method for determining a core spacing distance extending between a first optical fiber and a second optical fiber of a two-dimensional fiber array unit is provided. The two-dimensional fiber array unit comprises a first fiber array layer, and a second fiber array layer. The first fiber array layer comprises the first optical fiber defining a first end face configured to emit a first beam. The second fiber array layer comprises the second optical fiber defining a second end face configured to emit a second beam. The first fiber array layer and the second fiber array layer are spaced vertically apart. The first end face and the second end face are arranged on an angled end face of the fiber array unit. The angled end face extends from a base of the fiber array unit at an angle that is not perpendicular to a bottom surface of the base of the fiber array unit. The method comprises measuring, using at least one core pitch measurement device, a first vertical component of the first beam. The method further comprises measuring, using the at least one core pitch measurement device, a second vertical component of the second beam. The method further comprises determining a vertical spacing between the measured first vertical component of the first beam and the measured second vertical component of the second beam. The method further comprises determining an adjusted second vertical component of the second beam based on the angle of the angled end face and the determined vertical spacing. The method further comprises determining a core pitch error by comparing the adjusted second vertical component of the second beam to a desired vertical component for the second beam.

In some embodiments, the first optical fiber and the second optical fiber may be parallel. In some embodiments, the at least one core pitch measurement device may be configured to measure the first beam and the second beam in a parallel manner to the bottom surface of the base of the fiber array unit.

In some embodiments, the adjusted second vertical component of the second beam is provided by the following equation:

$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$

wherein Y′ is the adjusted second vertical component of the second beam, α is the angle of the angled end face, h′ is a measured vertical component distance spacing between the measured first vertical component and the measured second vertical component, n₀ is a refractive index of air, and n₁ is a refractive index of the angled end face of the fiber array unit. In some embodiments, the core spacing value may be the difference between the adjusted second vertical component and the measured first vertical component.

In yet another example embodiment, a method for determining a core pitch error of an optical fiber positioned in a two-dimensional fiber array unit is provided. The two-dimensional fiber array unit comprises a first fiber array layer, and a second fiber array layer. The first fiber array layer comprises a first optical fiber defining a first end face configured to emit a first beam. The second fiber array layer comprises the optical fiber defining a second end face configured to emit a second beam. The first fiber array layer and the second fiber array layer are spaced vertically apart. The first end face and the second end face are arranged on an angled end face of the fiber array unit. The angled end face extends from a base of the fiber array unit at an angle that is not perpendicular to a bottom surface of the base of the fiber array unit. The method comprises positioning at least one core pitch measurement device such that a measurement direction of the at least one core pitch measurement device is parallel to the bottom surface of the base of the fiber array unit, wherein the at least one core pitch measurement device is configured for at least vertical movement normal to the bottom surface of the base of the fiber array unit. The method further comprises measuring, using the at least one core pitch measurement device, a first horizontal component and a first vertical component corresponding to the first optical fiber. The method further comprises measuring, using the at least one core pitch measurement device, a second horizontal component and a second vertical component corresponding to the optical fiber. The method further comprises calculating an adjusted second vertical component of the optical fiber based on the angle of the angled end face, the measured first vertical component and the measured second vertical component. The method further comprises determining the core pitch error based on the adjusted second vertical component, the measured second horizontal component, a desired second horizontal component and a desired second vertical component, wherein the desired second horizontal component and the desired second vertical component yield desirable transmission characteristics.

In some embodiments, the adjusted second vertical component of the second beam is provided by the following equation:

$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$

wherein Y′ is the adjusted second vertical component of the second beam, α is the angle of the angled end face, h′ is a measured vertical component distance between the measured first vertical component and the measured second vertical component, n₀ is a refractive index of air, and n₁ is a refractive index of the angled end face of the fiber array unit.

In some embodiments, the fiber array unit is positioned on a wedge, and the second adjusted vertical component is provided by the following equation: Y′=h sin (α), wherein Y′ is the adjusted second vertical component, α is the angle of the angled end face, and h is a distance between the measured first vertical component and the measured second vertical component.

In yet another example embodiment, a two-dimensional fiber array unit produced by a process is provided. The process comprises forming the two-dimensional fiber array unit. The two-dimensional fiber array unit comprises a first fiber array layer and a second fiber array layer. The first fiber array layer comprises a first optical fiber defining a first end face configured to emit a first beam, and the second fiber array layer comprises a second optical fiber defining a second end face configured to emit a second beam. The first fiber array layer and the second fiber array layer are spaced vertically apart. The first end face and the second end face are arranged on an angled end face of the fiber array unit, and the angled end face extends from a base of the fiber array unit at an angle that is not perpendicular to a bottom surface of the base of the fiber array unit. The process further comprises confirming that the core pitch error is within a tolerance by positioning one of the fiber array unit or at least one core pitch measurement device relative to each other to enable measurement of at least one core pitch value. The confirmation further comprises measuring, using the at least one core pitch measurement device, a first horizontal component and a first vertical component corresponding to the first optical fiber of the first fiber array layer and measuring, using the at least one core pitch measurement device, a second horizontal component and a second vertical component corresponding to the second optical fiber of the second fiber array layer. The confirmation further comprises determining an adjusted second vertical component of the second optical fiber based on the angle of the angled end face, the measured first vertical component and the measured second vertical component. The confirmation further comprises determining a core pitch error based on the adjusted second vertical component, the measured second horizontal component, a desired second horizontal component and a desired second vertical component, wherein the desired second horizontal component and the desired second vertical component yield optimum transmission. The confirmation further comprises comparing the determined core pitch error to the tolerance.

In some embodiments, the adjusted second vertical component of the second beam is provided by the following equation:

$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$

wherein Y′ is the adjusted second vertical component, α is the angle of the angled end face, h′ is a measured vertical component distance between the measured first vertical component and the measured second vertical component, n₀ is a refractive index of air, and n₁ is a refractive index of the angled end face of the fiber array unit.

In some embodiments, confirming that the core pitch error is within a tolerance may further comprises positioning the two-dimensional fiber array unit on a wedge, and wherein the second adjusted vertical component is provided by the following equation: Y′=h sin (α), wherein Y′ is the adjusted second vertical component, α is the angle of the angled end face, and h is a distance between the measured first vertical component and the measured second vertical component.

In yet another example embodiment, a two-dimensional fiber array unit produced by a process is provided. The process comprises forming the two-dimensional fiber array unit. The two-dimensional fiber array unit comprises a first fiber array layer and a second fiber array layer. The first fiber array layer comprises a first optical fiber defining a first end face configured to emit a first beam. The second fiber array layer comprises a second optical fiber defining a second end face, configured to emit a second beam. The first fiber array layer and the second fiber array layer are spaced vertically apart. The first end face and the second end face are arranged on an angled end face of the fiber array unit. The angled end face extends from a base of the two-dimensional fiber array unit at an angle that is not perpendicular to a bottom surface of the base of the fiber array unit. The process further comprises confirming that the core pitch error is within a tolerance by measuring, using at least one core pitch measurement device, a first vertical component of the first beam, and measuring, using the at least one core pitch measurement device, a second vertical component of the second beam. Confirming that the core pitch error is within a tolerance further comprises determining a vertical spacing between the measured first vertical component of the first beam and the measured second vertical component of the second beam and determining an adjusted second vertical component of the second beam based on the angle of the angled end face and the determined vertical spacing. Confirming that the core pitch error is within a tolerance further comprises determining a core pitch error by comparing the adjusted second vertical component of the second beam to a desired vertical component of the second beam, and comparing the determined core pitch to the tolerance.

In some embodiments, the core pitch error is determined by the following equation: dRᵢ=\sqrt{dXᵢ²+dYᵢ²}, wherein dRᵢ is the core pitch error, dXᵢ is the difference between the desired second horizontal component and the measured second horizontal component, and dYᵢ is the difference between the desired second vertical component and the adjusted second vertical component.

### BRIEF DESCRIPTION OF THE SEVERAL VIEWS OF THE DRAWING(S)

Reference will now be made to the accompanying drawings, which are not necessarily drawn to scale, and wherein:

FIG. 1A illustrates a front view of an example two-dimensional fiber array unit, in accordance with some embodiments discussed herein;

FIG. 1B illustrates a side view of the fiber array unit shown in FIG. 1A, in accordance with some embodiments discussed herein;

FIG. 1C illustrates a top view of the fiber array unit shown in FIG. 1A with a portion removed for illustration purposes, in accordance with some embodiments discussed herein;

FIG. 2A illustrates a front view of an example fiber array unit, in accordance with some embodiments discussed herein;

FIG. 2B illustrates measurements of a core pitch and a core pitch error of the optical fibers of the example fiber array unit shown in FIG. 2A, in accordance with some embodiments discussed herein;

FIG. 3 illustrates positioning of the core pitch and the core pitch error of the optical fibers of the fiber array unit shown in FIG. 1A, in accordance with some embodiments discussed herein;

FIG. 4 illustrates a cross sectional view of an example fiber array unit, and a core pitch measurement device, in accordance with some embodiments discussed herein;

FIG. 5 illustrates a cross sectional view of another example fiber array unit with an angled end face, and a core pitch measurement device, in accordance with some embodiments discussed herein;

FIG. 6A illustrates a cross sectional view of the example fiber array unit with an angled end face shown in FIG. 5 being positioned on a wedge, in accordance with some embodiments discussed herein;

FIG. 6B illustrates a cross-sectional view of the example fiber array unit with an angled face shown in FIG. 6A with the wedge removed for illustrating example measurements and various angles, in accordance with some embodiments discussed herein;

FIG. 7 illustrates a flowchart of an example method determining the core pitch of a fiber array unit, in accordance with some embodiments discussed herein; and

FIG. 8 illustrates a flowchart of an example method for manufacturing a fiber array unit with a determined tolerance, in accordance with some embodiments discussed herein.

### DETAILED DESCRIPTION

Some example embodiments will now be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

Fiber array units (FAUs) comprise one or more optical fibers configured to transmit light data. FAU's may be one-dimensional, where the optical fibers are positioned in a single layer (e.g., along the horizontal or x-axis), or two-dimensional, where optical fibers are positioned in one of two layers, with one layer positioned vertically above another layer. In some embodiments, two-dimensional FAUs may have two or more layers of optical fibers separated by spacer layers. Two-dimensional FAU's may be used to create high fiber density optical interconnects for high density applications in optical communications. In order to achieve a high yield from the two-dimensional FAU, the measured core pitch values may be within a tolerance value. As FAUs are manufactured on a micron scale, the core pitch values may require precision and accuracy in measurement.

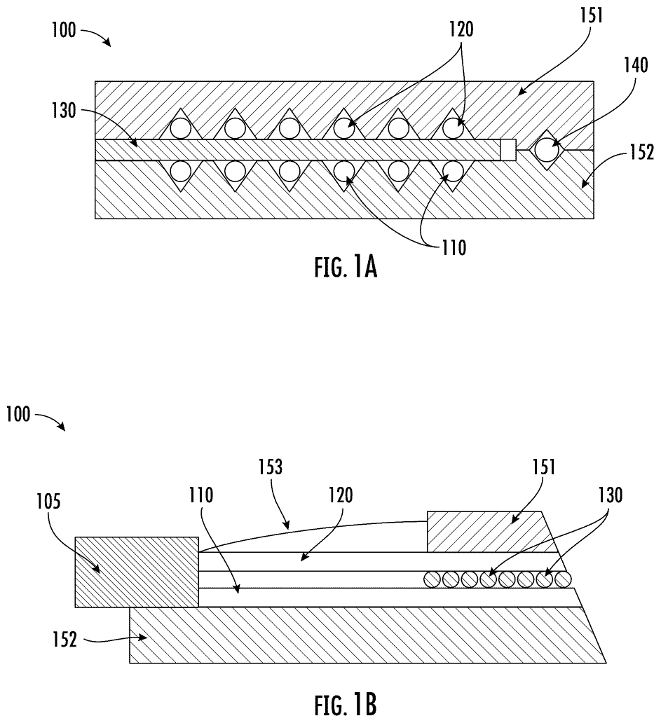

FIGS. 1A-C illustrate views of an example two-dimensional fiber array unit (2D FAU) 100. FIG. 1A illustrates a front view of the 2D FAU 100. The 2D FAU 100 comprises a first layer of optical fibers 110, positioned on a first substrate 152. In some embodiments, the first substrate 152 may be a V-grooved substrate to create a V-grooved fiber array unit, while in other embodiments the first substrate 152 may be a planar substrate. In some embodiments, the first substrate 152 may be a glass substrate, and in other embodiments the first substrate 152 may be formed of other material, such as ceramic material, silicon-based material, or metallic material.

In some embodiments, the first layer of optical fibers 110 may be adhered to the first substrate 152, such as with an adhesive. In some embodiments, the adhesive may be an epoxy, nano-particles, a glue, welding, or other adhesive to secure the position of the first layer of optical fibers 110 on the first substrate 152.

The 2D FAU 100 may further include a second layer of optical fibers 120. The second layer of optical fibers 120 may be positioned on one or more spacers 130. In some embodiments, the one or more spacers 130 may be positioned on the first layer of optical fibers 110. In this regard, the one or more spacers 130 may be configured to separate the first layer of optical fibers 110 and the second layer of optical fibers 120.

In some embodiments, a second substrate 151 is positioned about the second layer of optical fibers 120. In this regard, in some embodiments, the second substrate 151 may be a V-groove substrate such that each of the grooves of the second substrate 151 is about one of the optical fibers of the second layer of optical fibers 120. In some embodiments, the second substrate 151 may be a planar substrate. In this regard, a layer of epoxy or other adhesive may be positioned to surround each of the optical fibers within the second layer of optical fibers 120 such that the second layer of optical fibers 120 maintains the desired spacing on the spacer layer 130.

In some embodiments, each of the first substrate 152 and the second substrate 151 may be configured as V-groove substrates. In this regard, the one or more spacers 130 may be configured to abut the surfaces of each of the first substrate 152 and the second substrate 151. In some embodiments, the V-grooves may be sized such that the optical fibers of each of the first layer of optical fibers 110 and the second layer of optical fibers 120 may fit within the V-groove and may abut the one or more spacers 130. In some embodiments, the second substrate 151 may be a glass substrate, and in other embodiments the second substrate 151 may be formed of other material, such as ceramic material, silicon-based material, or metallic material.

In some embodiments, each of the first substrate 152 and the second substrate 151 may be configured to receive an alignment pin 140. In some embodiments, the alignment pin 140 may extend (e.g., longitudinally and parallel with the optical fibers) along the bodies of each of the first substrate 152 and the second substrate 151 to align the first substrate 152 and the second substrate 151. In this regard, in some embodiments, to form the 2D FAU 100, the first layer of optical fibers 110 may be positioned on the first substrate 152, and the second layer of optical fibers 120 may be positioned on the second substrate 151. The alignment pin 140 may be positioned on the first substrate 152 and the one or more spacers 130 may be positioned to abut and adhered to both of the first substrate 152 and the first layer of optical fibers 110. Then, in some embodiments, the second substrate 151 and the second layer of optical fibers 120 may be positioned to abut and adhered to the one or more spacers 130, and the alignment pin 140. In this regard aligning the second substrate 151 on the alignment pin 140 properly aligns each of the optical fibers in the second layer of optical fibers 120 relative to the optical fibers in the first layer of optical fibers 110. Although a one-to-one alignment of first layer optical fibers and second layer optical fibers is illustrated, some embodiments contemplate one or more of the optical fibers being offset relative to each other. In this regard, in some embodiments the alignment pin 140 may be designed to vertically stager the optical fibers within the first layer of optical fibers 110 and the second layer of optical fibers 120.

FIG. 1B illustrates a side view of the 2D FAU 100. In some embodiments, the one or more spacers 130 may be configured as more than one dummy fiber positioned between the first layer of optical fibers 110 and the second layer of optical fibers 120 (although any material or structure may be used for the one or more spacers). Utilizing more than one spacer may maintain the pitch of the optical fibers along the length of the 2D FAU 100.

In some embodiments, an epoxy 153 is positioned about the optical fibers of the 2D FAU 100. In some embodiments, the epoxy 153 secures the positioning of the optical fibers within the first layer of optical fibers 110 and the second layer of optical fibers 120 along the length of the optical fibers. Additionally, the epoxy may provide a protective layer so as to protect the bodies of the optical fibers.

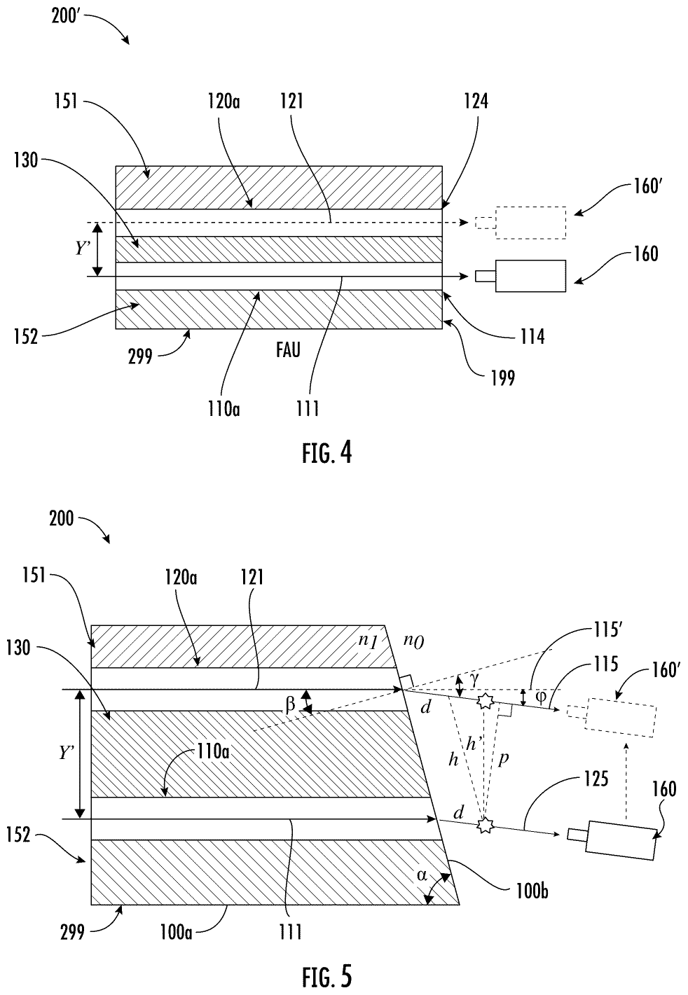

In some embodiments, as illustrated, the 2D FAU 100 may define an angled end face (see e.g., 100b FIG. 5). In this regard each of the first substrate 152, the second substrate 151, and each optical fiber within the first layer of optical fibers 110 and second layer of optical fibers 120 may define angled end faces. The angled end face may change how the light beams reflect at the end face, and may affect the losses when coupling the 2D FAU to other components.

In some embodiments, the second substrate 151 may not extend along the entire length of the optical fibers of the second layer of optical fibers 120. In this regard, the second substrate 151 may be configured as a cover of the 2D FAU 100.

In some embodiments, the optical fibers of the first optical fiber layer 110 and the second optical fiber layer 120 may be coupled to a data source 105. In some embodiments, the data source may provide light data to each of the optical fibers within the 2D FAU 100.

FIG. 1C illustrates a top view of the 2D FAU 100 without the second substrate. Thus, as illustrated, the second layer of optical fibers 120 may be positioned over the one or more spacers 130, while the first layer of optical fibers (e.g., 110 FIG. 1B) may be positioned directly below the second layer of optical fibers 120.

In some embodiments, the alignment pin 140 may extend the length of the second substrate (e.g., 151 FIG. 1B), while in other embodiments, the alignment pin 140 may extend the length of the first substrate 152.

Returning briefly to FIG. 1A, each of the optical fibers within the first layer of optical fibers 110 and the second layer of optical fibers 120 define a core pitch value. In this regard, the position of each optical fiber may comprise a horizontal component and a vertical component. The horizontal component and vertical components of each optical fiber may be measured relative to a reference fiber.

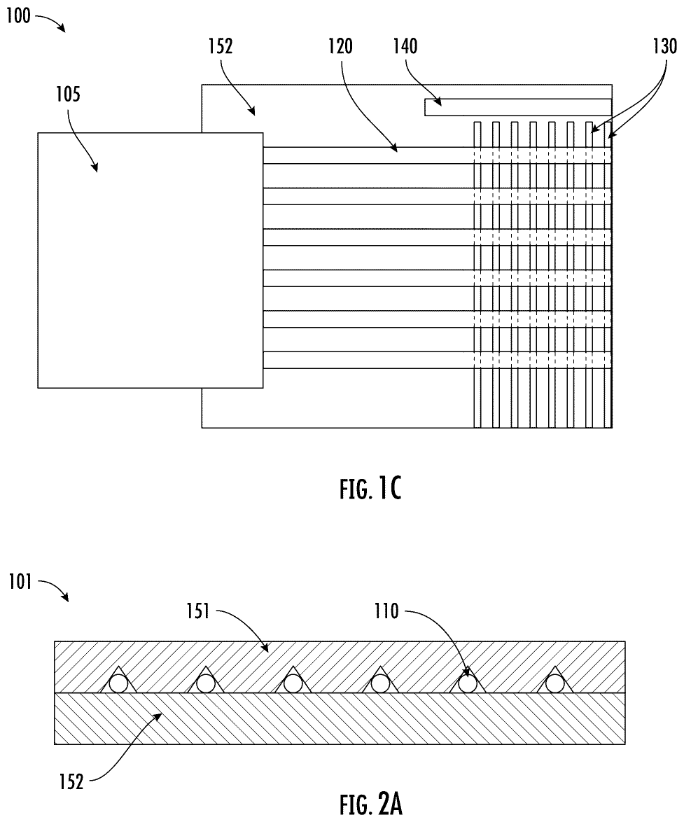

To explain, a one-dimensional FAU 101 is illustrated in FIG. 2A. The one-dimensional FAU 101 comprises a first layer of optical fiber 110 positioned on a first substrate 152 and aligned with a second substrate 151. Each of the optical fibers within the FAU 101 defines a core pitch value. FIG. 2B illustrates a schematic illustration of the one-dimensional FAU 101 illustrated in FIG. 2A. Each of the optical fibers 1-6 of the FAU comprise a core pitch measurement 103 as measured by a core pitch measurement device (e.g., 160 FIG. 5) indicated by a measured horizontal component X′ᵢ and a measured vertical component Y′ᵢ where i is the fiber number. In addition to the measured core pitch value 103, each optical fiber comprises a desired core pitch value 103′ comprising a desired horizontal component Xᵢ and a desired vertical component Yᵢ , where i is the fiber number.

Deviation from either the desired horizontal component Xᵢ or the desired vertical component Yᵢ causes a core pitch error, thereby leading to yield losses. Thus, it may be desirable for the optical fibers within fiber array units to have minimal deviation in each of the measured horizontal component X′ᵢ and the measured vertical component Y′ᵢ , as large deviations may render the fiber array unit unusable. Notably, as the optical fibers are adhered to the first substrate and/or second substrate, the optical fibers may not be repositioned after manufacture.

The desired core pitch value 103′ of each of the optical fibers may be based on a reference fiber. In the illustrated embodiment, the reference fiber may be optical fiber 1. In this regard, the measured core pitch value of optical fiber 1 (X′₁ and Y′₁), may also be the desired core pitch value of optical fiber 1 (X₁ and Y₁). Therefore, in some embodiments, the measured core pitch values, and the desired core pitch values of the other optical fibers (2-6) may be based on the reference fiber.

The desired core pitch value 103′ of each of the optical fibers 1-6 may define a desired vertical component Yᵢ that is, for example, aligned along a reference line 135. In some embodiments, the reference line 135 may indicate a 0 vertical component Yᵢ and may be the vertical component of optical fiber 1 Y₁ (e.g., the reference fiber). Thus, deviation from the reference line 135 may be referred to as dYᵢ. In this regard, to minimize core pitch error deriving from the vertical component Yᵢ of the core pitch value, the core (e.g., 113 FIG. 2B) of the optical fibers (1-6) may be aligned on the reference line 135. Although core position may be determined by the position the optical fiber is adhered to the first substrate (e.g., 152), the manufacturing of the individual optical fiber, the method of cleaving, and/or angle of the end face may also contribute to the beam (e.g., 115, 125) exiting the core of the optical fiber at the FAU air interface.

The desired horizontal component Xᵢ may be the distance between two neighboring optical fibers along the x-axis. In the example embodiment, each of the optical fibers (1-6) within the first layer of optical fibers are ideally spaced C_{P} apart. Thus, the desired position of each optical fiber along the x-axis may be C_{P} distance from a corresponding neighboring optical fiber.

In the illustrated embodiment, optical fiber 1, as the reference fiber, defines a horizontal component X₁ of 0. Thus, the ideal horizontal component Xᵢ of optical fibers 2-5 may be defined as (i−1)C_{P} where i is the fiber position.

FIG. 2B further illustrates the core pitch error with reference to optical fiber 2. The desired position 110′ of a core 113′ of optical fiber 2 may define a horizontal component X₂=Cₚ, and a vertical component Y₂=0. However, as illustrated, a core 113 of optical fiber 2 deviates from the desired core pitch in both the horizontal component X′₂ and vertical component Y′₂. As illustrated the core 113 of optical fiber 2 is positioned below the reference line 135, and thus, deviates from the desired vertical component of Y₂=0 by dY₂. Thus, the measured vertical component is Y′₂=0+dY₂. Similarly, the core 113 of optical fiber 2 is shifted in the horizontal direction from the desired horizontal component X₂=C_{P} by dX₂. Thus, the measured horizontal component X′₂=C_{P}+dX₂. In some embodiments, the core pitch error may be defined individually in each direction as a horizontal component dX and as a vertical component dY, while in other embodiments, the core pitch error dRᵢ may be defined as a single core pitch error determined by equation 1:

$${dR}_{i} = \sqrt{{dX}_{i}^{2} + {dY}_{i}^{2}} \qquad ( 1 )$$

where dRᵢ is the core pitch error, i is the fiber number, dX is the difference in measured horizontal component and the desired horizontal component, and dY is the difference in the measured vertical component and the desired vertical component. The core pitch error dRᵢ should be as small as possible to minimize yield losses in a fiber array unit.

The core pitch error may then be compared to a tolerance for the fiber array unit to determine if the core pitch values for each optical fiber fall within the acceptable tolerance, such that the fiber array unit was acceptably manufactured.

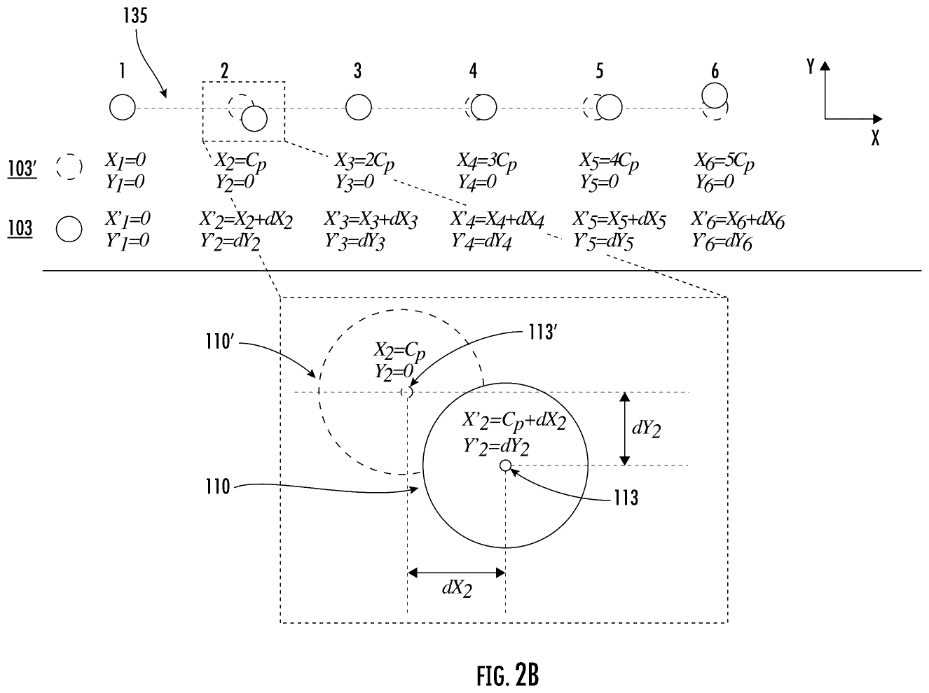

The measurement method for the one-dimensional fiber array 101 illustrated in FIG. 2A may be applied to the 2D FAU 100 illustrated in FIG. 1A. FIG. 3 illustrates a schematic drawing of a two-dimensional fiber array unit 102 with corresponding desired core pitch values and measured core pitch values of each optical fiber.

In the schematic drawing illustrated in FIG. 3, optical fibers 1-6 comprise one layer of optical fibers and optical fibers 7-12 comprise another layer of optical fibers. As illustrated, compared to FIG. 2A, optical fibers 1-6 may correspond to the second layer of optical fibers 120, and optical fibers 7-12 may correspond to the first layer of optical fibers 110.

In the illustrated embodiment, optical fiber 1 is the reference fiber. In this regard, the desired horizontal component Xᵢ and desired vertical component Y ᵢ of each optical fiber are based on optical fiber 1. As illustrated, the desired core pitch value and the measured core pitch value of optical fiber 1 are equivalent. Thus, the desired core pitch values of the other optical fibers may be defined based on the core pitch value of the optical fiber 1. In the illustrated example, optical fiber 1 comprises a measured horizontal component of X′₁=0 and a measured vertical component Y′₁=0.

As discussed with reference to FIG. 2B, each optical fiber 2-6 may have a desired vertical component of Yᵢ=0. However, each optical fiber 7-12 may define a desired vertical component Yᵢ=−S, wherein S is the desired vertical spacing between each of the optical fibers. As discussed with reference to FIG. 2B, the desired horizontal component Xᵢ of each optical fiber may be spaced C_{P} distance apart. In this regard, the second layer of optical fibers (1-6) is vertically aligned with the first layer of optical fiber (7-12), thus, the desired horizontal component of each of the optical fibers (7-12) correspond to the desired horizontal components of the respective optical fiber 1-6 in the second layer.

Thus, as discussed each of the optical fibers 1-6 may define a desired horizontal spacing of Xᵢ=(i−1)C_{P}, wherein i is the position of the optical fiber in relation to the reference fiber (e.g., optical fiber 1). In this regard, the optical fibers in the first layer of optical fibers (e.g., 7-12), may have an i value corresponding to the vertically aligned optical fiber. For example, optical fiber 10 may have an i value of 4, since optical fiber 10 is vertically aligned with optical fiber 4.

FIG. 3 further illustrates each of the desired core pitch values 103′ and measured core pitch values 103, for the second layer of optical fibers, and the desired core pitch values 104′ and the measured core pitch values 104 for each of the first layer of optical fibers. The core pitch error in each of the optical fibers, as discussed with reference to FIG. 2B should be within a tolerance value to be a quality fiber array unit.

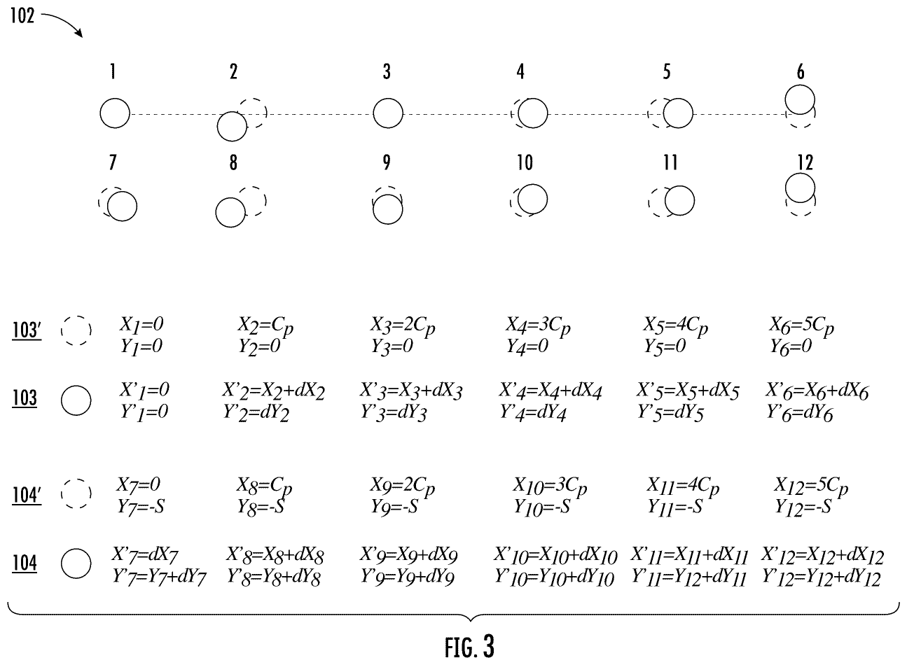

FIG. 4 illustrates a cross sectional view of an example fiber array unit FAU 200′. The FAU 200′ comprises a first optical fiber 110a within the first layer of optical fibers 110, and a second optical fiber 120a within the second layer of optical fibers 120. The first optical fiber 110a comprises a first end face 114, configured to emit a first beam 111. The second optical fiber 120a comprises a second end face 124, configured to emit a second beam 121. The position of the emitted beam (e.g., the first beam 111 and the second beam 121) is measured by a core pitch measurement device 160. The core pitch measurement device 160 may be configured to move relative to the FAU 200′. In this regard, the core pitch measurement device 160 is configured to move from a first position to measure the first core pitch value comprising a first horizontal component (e.g., X₁) and a first vertical component (e.g., Y₁) of the first optical fiber 120a to a second position 160′ to measure the second core pitch value comprising a second horizontal component (e.g., X₇) and a second vertical component (e.g., Y₇) of the second optical fiber 120a.

The core pitch measurement device 160 may be configured to move vertically with respect to the FAU 200′. In the illustrated embodiment, the core pitch measurement device 160 may move along a line perpendicular to a bottom surface 299 of the FAU 200′ between the measurement of the first beam 111 and the second beam 121. Notably, the end face 199 of the FAU 200 extends perpendicularly to the bottom surface 299 of the FAU 200′. In this regard, the distance between the first end face 114 and the core pitch measurement device 160 and the second optical fiber end face 124 and the core pitch measurement device 160′ is the same, yielding an accurate measurement.

In some embodiments, rather than the core pitch measurement device 160 moving from a first position to a second position, the FAU may be repositioned relative to the core pitch measurement device 160.

In the illustrated embodiment, the first end face 114 and the second end face 124, and thus, the FAU 200′ define a polish angle of 90 degrees (with respect to the bottom surface 299). In this regard, the first beam 111 and the second beam 121 exit the first core of the first optical fiber 110a and the second core of the second optical fiber 120a, respectively, without any refraction at the air-glass interface. Thus, the vertical component Y′ of the core pitch value between the first optical fiber 110a and the second optical fiber 120a is accurately measured.

In some embodiments, as illustrated in FIG. 5, the 2D FAU 200 may define an angled end face 100b. An angle α may be measured between a bottom surface 299 of a base 100a of the FAU 200 and the angled end face 100b. In some embodiments, the angle α may be greater than 0 degrees and less than 90 degrees. In some embodiments, the angle α may be greater than 80 degrees. In some embodiments, the angle α may be specified for the application of the 2D FAU 200. As noted herein, having an angle to the angled end face 100b may introduce error to the core pitch values measured by the core pitch measurement device 160 according to the prior described method of measuring.

To explain, the angled end face 100b creates refraction at the air-glass interface. Thus, the second beam 121 exits the angled end face 100b as a refracted second beam 115, rather than extending out of the angled end face 100b as an unrefracted second beam 115′ as in the example with a polish angle of 90 degrees. Similarly, the first beam 111 exits the angled end face 100b as a refracted first beam 125.

With reference to FIG. 5, when the core pitch measurement device 160 measures a first vertical component and a first horizontal component of the first beam 125 at the first position 160, and the core pitch measurement device 160 measures a second horizontal component and a second vertical component at the second position 160′ (e.g., vertically displaced the desired vertical distance between the arrays for example) the core pitch measurement device 160 is not measuring the position of the core of the respective optical fiber, but rather the horizontal component and the vertical component of the refracted beam (notably the measurement positions are illustrated by the stars). In general, the first refracted beam 125 and the second refracted beam 115 may define the same horizontal component (e.g., Xᵢ) as a non-refracted beam. However, the vertical component (e.g., Yᵢ) may deviate due to the refraction.

Thus, in the illustrated embodiment, the measured vertical component spacing distance between the first refracted beam 125 and the second refracted beam 115 is indicated as h′. Said differently the measured vertical component distance h′ represents the difference between the second vertical component of the second refracted beam 115 and the first vertical component of the first refracted beam 125. Due to the refraction at the angled end face 100b, the measured vertical component distance h′ between the first refracted beam 125 and the second refracted beam 115 may be different than the actual vertical component Y′ (or adjusted vertical component) between the first optical fiber 110a and the second optical fiber 120a.

As discussed above, minor inaccuracies in measurement of the core pitch value may lead to large and unacceptable core pitch error calculations, which may prevent use of the manufactured FAU. Thus, it is necessary to determine a way to accurately calculate the vertical component of the core pitch in 2D FAU's with an angled end face.

The measured vertical component distance h′ and the angle α of the 2D FAU 200 may be used to determine the vertical component Y′ between the first optical fiber 110a and the second optical fiber 120a. To accurately determine the actual vertical component Y′ using the second optical fiber 120a as a reference, the angle β between the second beam 121 and the normal angle of the angled end face 100b is given by equation 2:

$$β = 90 - α \qquad ( 2 )$$

Using Snell's law, the angle γ between the second refracted beam 125 and the normal angle to the angled end face 100b may be calculated with equation 3:

$$γ = {sin}^{- 1} ( \frac{n 1 sin β}{n 0} ) = {sin}^{- 1} ( \frac{n 1 sin ( 90 - α )}{n 0} ) = {sin}^{- 1} ( \frac{n 1 cos ( α )}{n 0} ) \qquad ( 3 )$$

Where n₀ is the refractive index of air, and n₁ is the refractive index of glass (e.g., the first substrate 152 and the second substrate 151).

The end face distance h between the first beam 111 and the second beam 121 parallel to the angle end face 100b may be calculated by equation 4:

$$h = \frac{{Y}^{′}}{sin ( α )} \qquad ( 4 )$$

The perpendicular distance p between the first refracted beam 125 and the second refracted beam 115 may be determined by equation 5:

$$p = h cos ( γ ) = \frac{{Y}^{′} cos ( γ )}{sin ( α )} \qquad ( 5 )$$

The measured distance h′ between the first refracted beam 125 and the second refracted beam 115 may be derived from equations 4 and 5 yielding equation 6:

$${h}^{′} = \frac{p}{cos φ} = \frac{{Y}^{′} cos ( {sin}^{- 1} ( \frac{n 1 cos ( α )}{n 0} ) ) )}{sin α cos ( {sin}^{- 1} ( \frac{n 1 cos ( α )}{n 0} ) - ( 90 - α ) )} \qquad ( 6 )$$

Using equation 6, the relationship between the measured vertical component distance h′ and the actual vertical component Y′ is determined in equation 7:

$${Y}^{′} = \frac{{h}^{′} sin α cos ( {sin}^{- 1} ( \frac{{n}_{1} cos ( α )}{{n}_{0}} ) - ( 90 - α ) )}{cos ( {sin}^{- 1} ( \frac{{n}_{1} cos ( α )}{{n}_{0}} ) ) )} \qquad ( 7 )$$

In an example embodiment, a FAU defines an angle α of 84°, and the measured vertical component distance h′ is 108 microns. Thus, without the correction, the measured vertical component of the core pitch is determined to be 108 microns. However, after factoring in the described variables the actual vertical component Y′ is calculated using equation 7, the actual vertical component is 108.6 microns.

Without this correction, the 0.6 micron error in the measured vertical component distance may be carried over to the error in the vertical component and further into the core pitch error. In some embodiments, a core pitch error (e.g., vertical component and horizontal component) may be required to be less than 1.5 microns. In this regard, in the example embodiment without calculating the actual vertical component, the overall core pitch error may be artificially increased by 0.6 microns. In some embodiments, an error of 0.6 microns may be calculated to lower the yield of the 2D FAU 200 by between 10-30%.

Accordingly, various example embodiments adjust the measurement of the core pitch measurement device to enable accurate determination as to whether the fiber array unit manufactured falls within an acceptable tolerance range.

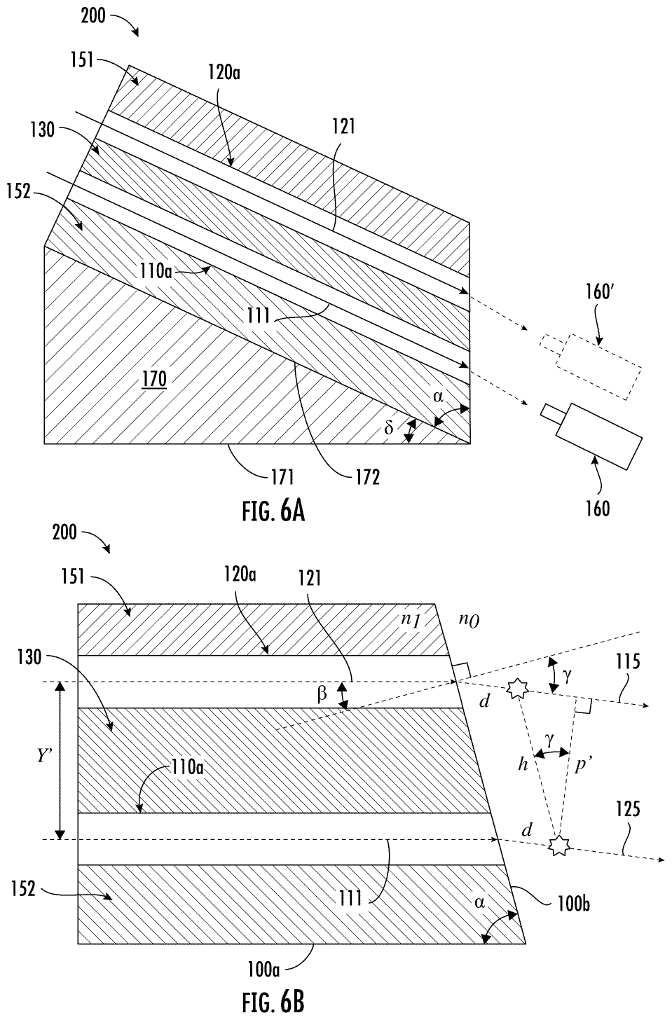

In some embodiments, a wedge can be employed during core pitch measurements. However, a similar error in the vertical component measurement occurs by the relative vertical positioning of the core pitch measurement device. Notably, however, a different adjustment is required for such a measurement method. Accordingly, some embodiments provide a second calculation adjustment, which is illustrated with reference to FIGS. 6A-B. The adjustment may allow the core pitch measurement device 160 to maintain the same distance d between the core pitch measurement device 160 and the angled end face of the FAU between the first layer of optical fibers and the second layer of optical fibers. In the measurement correction illustrated with reference to FIG. 5 the distance d between the end face 100b and the core pitch measurement device changes from the first refracted beam 125 to the second refracted beam 115. In this regard, although the core pitch measurement device 160 may be in focus for the measurement of the first refracted beam 125, the core pitch measurement device 160′ may be out of focus when moved to the second position to measure the second refracted beam 115.

To alleviate the focus error, in another example embodiment, the 2D FAU 200 may be positioned on a wedge 170. The wedge 170 may define a wedge angle δ measured between a wedge base 171 and a wedge face 172.

The base (e.g., 100a FIG. 5) of the 2D FAU 100 may be positioned on the wedge base 171. The wedge angle δ may be chosen such that the sum of the wedge angle δ and the angle α equal 90 degrees. In this regard, the distance (e.g., d FIG. 6B) between the core pitch measurement device 160 and end face 100b at the first optical fiber 110a and the second optical fiber 120a is the same at the first position and the second position 160′. Therefore, the core pitch measurement device 160 measures the vertical components of the first refracted beam 125 and the second refracted beam parallel to the end face, thus, measuring an end face distance h when the 2D FAU 200 is positioned on the wedge 170. In this regard, equation 4, may be used to determine the actual vertical component Y′ between the first optical fiber 110a and the second optical fiber 120b. Accordingly, the actual vertical component Y′ can be determined, in this case, as Y′=h sin α.

Returning to the example where the angle α of the angled end face 100b is 84°, using the above equation, the actual vertical component Y′ would be Y′=0.99452 h. If the 2D FAU 200 were positioned on a wedge 170 with a wedge angle δ of 6°, the end face distance h would be measured as 109.198 microns, while the actual vertical component Y′ would be 108.6 microns. Thus, the end face h measurement results in an increase that is an error of almost 0.6 microns.

As discussed with reference to FIG. 3, the actual vertical component Y′ may be used to determine the core pitch value of the optical fiber, and the core pitch error of the optical fiber when compared to a reference fiber.

Thus, traditional measurement methods for two-dimensional fiber array units insert significant error into the core pitch determination and thus, the determination of quality fiber array units. As described earlier, when the measurement of the vertical components is incorrect, the error flows into the core pitch determination, and thus, the core pitch error. Indeed, without the corrected approach provided by various example embodiments, the errors in the vertical component (e.g., Yᵢ) due to the inaccuracies in measuring the vertical component of the refracted beams (e.g., 115, 125) may lead to an FAU that is within an error tolerance being discarded, and alternatively may lead to an FAU that is outside of the error tolerance being sent to a customer.

### Example Flowchart(s)

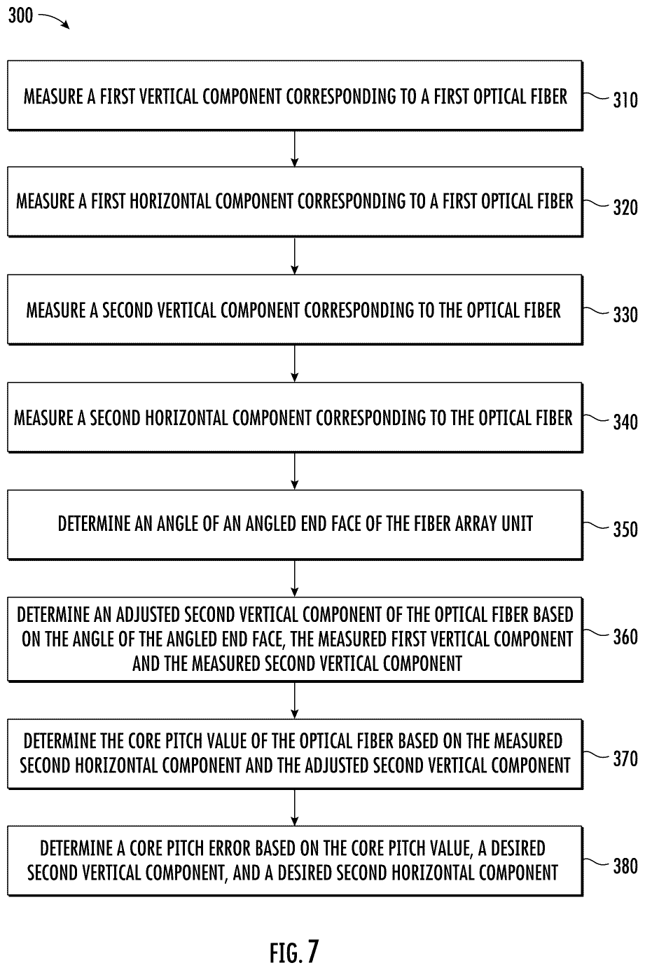

FIG. 7 is a flow chart illustrating an example method 300 for determining the core pitch value of an optical fiber based on the measured second horizontal component and the adjusted vertical component, in accordance with some embodiments discussed herein. At operation 310, a first vertical component corresponding to a first optical fiber is measured. In some embodiments the first vertical component may be a reference measurement. At operation 320, a first horizontal component corresponding to the first optical fiber may be measured. In this regard, the first vertical component measurement and the first horizontal component measurement may be considered the core pitch of the first optical fiber, and may be taken by a core pitch measurement device (notably, while provided separately, the measurements may be taken together at the same time).

At operation 330, a second vertical component corresponding to an optical fiber may be measured. At operation 340, a second horizontal component corresponding to the optical fiber may be measured (notably, while provided separately, the measurements may be taken together at the same time).

At operation 350, an angle of an angled end face of the fiber array unit may be determined. The angle may be taken between the base of the first substrate of the FAU (e.g., the bottom surface) and the angled end face of the FAU. In this regard, each end of the first optical fiber and the optical fiber may fall along the angle.

At operation 360, an adjusted second vertical component of the optical fiber is determined based on the angle of the angled end face, the measured first vertical component and the measured second vertical component. In some embodiments, the adjusted second vertical component may be the actual vertical component Y′, as described herein.

At operation 370, the core pitch value of the optical fiber is determined based on the measured second horizontal component and the adjusted second vertical component.

At operation 380, the core pitch error is determined, based on the core pitch value, a desired second vertical component and a desired second horizontal component.

While various operations are illustrated in FIG. 7 and described herein in a certain order, the order of operations may be altered in other embodiments. Additionally, while various operations are illustrated in FIG. 7 and described herein, certain operations may be omitted in some embodiments, and additional operations may be performed in some embodiments.

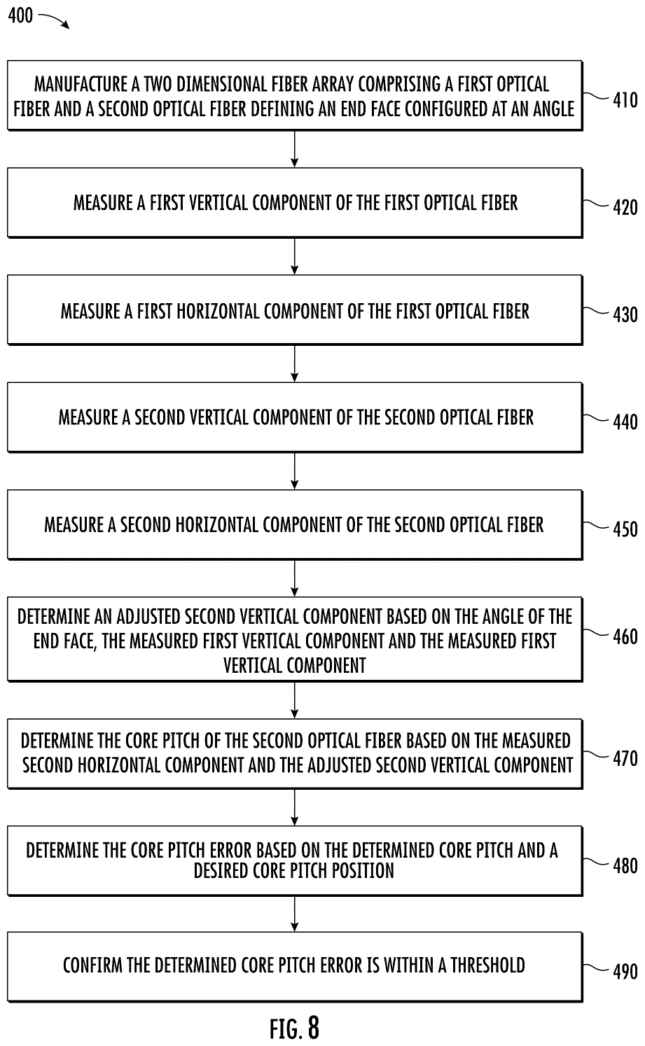

FIG. 8 is a flow chart illustrating an example method 400 for manufacturing an FAU and confirming that the FAU is within a threshold tolerance error, in accordance with some embodiments discussed herein. At operation 410, a two-dimensional FAU is manufactured comprising a first layer of optical fibers with a first optical fiber and a second layer of optical fibers with a second optical fiber. Notably, the FAU defines an end face configured at an angle. In this regard, the angled end face of the FAU is configured at an angle that is not 90 degrees with respect to a bottom surface of the FAU. At operation 420, a first vertical component corresponding to a first optical fiber is measured. In some embodiments, the first vertical component may be a reference measurement. At operation 430, a first horizontal component corresponding to the first optical fiber may be measured. In this regard, the first vertical component measurement and the first horizontal component measurement may be considered the core pitch of the first optical fiber and may be taken by a core pitch measurement device (notably, while provided separately, the measurements may be taken together at the same time).

At operation 440, a second vertical component of the second optical fiber is measured. At operation 450, a second horizontal component of the second optical fiber is measured (notably, while provided separately, the measurements may be taken together at the same time).

At operation 460, an adjusted second vertical component is determined based on the angle of the end face, the measured first vertical component, and the measured second vertical component. In some embodiments, the adjusted second vertical component is further determined based on the refractive index of the FAU, and the refractive index of air.

At operation 470, the core pitch value of the second optical fiber is determined based on the measured second horizontal component and the adjusted second vertical component.

At operation 480, the core pitch error is determined based on the core pitch value of the second optical fiber, and a desired core pitch position. In some embodiments, the desired core pitch position is based on the desired second vertical position and the desired second horizontal position of the core of the second optical fiber.

At operation 490, the core pitch error is compared to a threshold tolerance value. In some embodiments, if the core pitch error is greater than the threshold tolerance value, the FAU is discarded.

While various operations are illustrated in FIG. 8 and described herein in a certain order, the order of operations may be altered in other embodiments. Additionally, while various operations are illustrated in FIG. 8 and described herein, certain operations may be omitted in some embodiments, and additional operations may be performed in some embodiments.

### Conclusion

It will therefore be readily understood by those persons skilled in the art that the inventions disclosed herein are susceptible of broad utility and application. Many embodiments and adaptations other than those herein described, as well as many variations, modifications and equivalent arrangements, will be apparent from or reasonably suggested by the foregoing description and disclosure, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention.

The foregoing disclosure is not intended or to be construed to limit the present invention or otherwise to exclude any such other embodiments, adaptations, variations, modifications and equivalent arrangements.

1. A method for determining a core pitch value of an optical fiber positioned in a two-dimensional fiber array unit, the fiber array unit comprising a first fiber array layer, and a second fiber array layer, the first fiber array layer comprising a first optical fiber defining a first end face, wherein the first end face is configured to emit a first beam, and the second fiber array layer comprising the optical fiber defining a second end face, wherein the second end face is configured to emit a second beam, wherein the first fiber array layer and the second fiber array layer are spaced vertically apart, and wherein the first end face and the second end face are arranged on an angled end face of the fiber array unit, wherein the angled end face extends from a base of the fiber array unit at an angle that is not perpendicular to a bottom surface of the base of the fiber array unit, the method comprising:
positioning one of the fiber array unit or at least one core pitch measurement device relative to each other to enable measurement of at least one core pitch value;
measuring, using the at least one core pitch measurement device, a first horizontal component and a first vertical component corresponding to the first optical fiber of the first fiber array layer;
measuring, using the at least one core pitch measurement device, a second horizontal component and a second vertical component corresponding to the optical fiber of the second fiber array layer;
determining an adjusted second vertical component of the optical fiber based on the angle of the angled end face, the measured first vertical component and the measured second vertical component; and
determining the core pitch value of the optical fiber based on the measured second horizontal component and the adjusted second vertical component.

2. The method of claim 1, wherein the first optical fiber and the optical fiber are parallel.

3. The method of claim 1, wherein a measurement direction of the at least one core pitch measurement device is positioned so as to be parallel to the bottom surface of the base of the fiber array unit.

4. The method of claim 1, wherein the angled end face of the two-dimensional fiber array unit has a glass cover.

5. The method of claim 1, wherein the adjusted second vertical component of the second beam is provided by the following equation:
$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$
wherein Y′ is the adjusted second vertical component of the second beam, a is the angle of the angled end face, h′ is a measured vertical component distance between the measured first vertical component and the measured second vertical component, n₀ is a refractive index of air, and n₁ is a refractive index of the angled end face of the fiber array unit.

6. The method of claim 1, wherein the two-dimensional fiber array unit is positioned on a wedge that is positioned on a flat surface, wherein the wedge is configured such that the angled end face is normal to the flat surface.

7. The method of claim 6, wherein the adjusted second vertical component is provided by the following equation: Y′=h sin (α), wherein Y′ is the adjusted second vertical component of the second exit pitch, α is the angle of the angled end face, and h is a distance between the measured first vertical component and the measured second vertical component.

8. The method of claim 1, further comprising determining a first core pitch value of the first optical fiber based on the measured first horizontal component and the measured first vertical component.

9. The method of claim 1, further comprising:
determining a core pitch error based on the adjusted second vertical component, the measured second horizontal component, a desired second horizontal component and a desired second vertical component, wherein the desired second horizontal component and the desired second vertical component yield desirable transmission characteristics.

10. The method of claim 9, wherein the core pitch error is determined by the following equation: dRᵢ=\sqrt{dXᵢ²+dYᵢ²}, wherein dRᵢ is the core pitch error, dXᵢ is the difference between the desired second horizontal component and the measured second horizontal component, and dYᵢ is the difference between the desired second vertical component and the adjusted second vertical component.

11. The method of claim 1, wherein the first end face and the second end face are coated with an anti-reflective coating.

12. The method of claim 1, further comprising:
repositioning one of the two-dimensional fiber array unit or the at least one core pitch measurement device to enable core pitch measurement of a second core pitch value.

13. A method for determining a core spacing distance extending between a first optical fiber and a second optical fiber of a two-dimensional fiber array unit, the fiber array unit comprising a first fiber array layer and a second fiber array layer, the first fiber array layer comprising the first optical fiber, wherein the first optical fiber defines a first end face and is configured to emit a first beam, and the second fiber array layer comprising the second optical fiber, wherein the second optical fiber defines a second end face and is configured to emit a second beam, wherein the first fiber array layer and the second fiber array layer are spaced vertically apart, and wherein the first end face and the second end face are arranged on an angled end face of the fiber array unit, wherein the angled end face extends from a base of the fiber array unit at an angle that is not perpendicular to a bottom surface of the base of the fiber array unit, the method comprising:
measuring, using at least one core pitch measurement device, a first vertical component of the first beam;
measuring, using the at least one core pitch measurement device, a second vertical component of the second beam;
determining a vertical spacing between the measured first vertical component of the first beam and the measured second vertical component of the second beam;
determining an adjusted second vertical component of the second beam based on the angle of the angled end face and the determined vertical spacing; and
determining a core pitch error by comparing the adjusted second vertical component of the second beam to a desired vertical component for the second beam.

14. The method of claim 13, wherein the first optical fiber and the second optical fiber are parallel.

15. The method of claim 13, wherein the at least one core pitch measurement device is configured to measure the first beam and the second beam in a parallel manner to the bottom surface of the base of the fiber array unit.

16. The method of claim 13, wherein the adjusted second vertical component of the second beam is provided by the following equation:
$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$
wherein Y′ is the adjusted second vertical component of the second beam, α is the angle of the angled end face, h′ is a measured vertical component distance spacing between the measured first vertical component and the measured second vertical component, n₀ is a refractive index of air, and n₁ is a refractive index of the angled end face of the fiber array unit.

17. The method of claim 16, wherein the core spacing value is the difference between the adjusted second vertical component and the measured first vertical component.

18. A method for determining a core pitch error of an optical fiber positioned in a two-dimensional fiber array unit, the fiber array unit comprising a first fiber array layer and a second fiber array layer, the first fiber array layer comprising a first optical fiber defining a first end face, wherein the first end face is configured to emit a first beam, and the second fiber array layer comprising the optical fiber defining a second end face, wherein the second end face is configured to emit a second beam, wherein the first fiber array layer and the second fiber array layer are spaced vertically apart, and wherein the first end face and the second end face are arranged on an angled end face of the fiber array unit, wherein the angled end face extends from a base of the fiber array unit at an angle that is not perpendicular to a bottom surface of the base of the fiber array unit, the method comprising:
positioning at least one core pitch measurement device such that a measurement direction of the at least one core pitch measurement device is parallel to the bottom surface of the base of the fiber array unit, wherein the at least one core pitch measurement device is configured for at least vertical movement normal to the bottom surface of the base of the fiber array unit;
measuring, using the at least one core pitch measurement device, a first horizontal component and a first vertical component corresponding to the first optical fiber;
measuring, using the at least one core pitch measurement device, a second horizontal component and a second vertical component corresponding to the optical fiber;
calculating an adjusted second vertical component of the optical fiber based on the angle of the angled end face, the measured first vertical component and the measured second vertical component; and
determining the core pitch error based on the adjusted second vertical component, the measured second horizontal component, a desired second horizontal component and a desired second vertical component, wherein the desired second horizontal component and the desired second vertical component yield desirable transmission characteristics.

19. The method of claim 18, wherein the adjusted second vertical component of the second beam is provided by the following equation:
$${Y}^{′} = \frac{{h}^{′} sin α cos ( {sin}^{- 1} ( \frac{{n}_{1} cos ( α )}{{n}_{0}} ) - ( 90 - α ) )}{cos ( \frac{{sin}^{- 1} ( {n}_{1} cos ( α ) )}{{n}_{0}} )} ,$$
wherein Y′ is the adjusted second vertical component of the second beam, α is the angle of the angled end face, h′ is a measured vertical component distance between the measured first vertical component and the measured second vertical component, n₀ is a refractive index of air, and n₁ is a refractive index of the angled end face of the fiber array unit.

20. The method of claim 18, wherein the fiber array unit is positioned on a wedge, and the second adjusted vertical component is provided by the following equation: Y′=h sin (α), wherein Y′ is the adjusted second vertical component, α is the angle of the angled end face, and h is a distance between the measured first vertical component and the measured second vertical component.
